(19) United States
(12) Patent Application Publication
(10) Pub. No.: US 2013/0115502 A1
(43) Pub. Date: May 9, 2013

(54) MOUNTING DEVICE FOR BATTERY

(71) Applicant: HAI-QING ZHOU, Shenzhen City (CN)

(72) Inventor: HAI-QING ZHOU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/294,192

(22) Filed: Nov. 11, 2011

(30) Foreign Application Priority Data
Nov. 4, 2011 (CN) 201110344352.5

(51) Int. Cl. H01M 2/10

(52) U.S. Cl. 429/100; 429/96

(57) ABSTRACT

A mounting device for mounting a battery includes a base board and a fixing member. The board forming two tabs to abut against opposite sides of the battery and two hooks to locate at opposite ends of the battery. The fixing member is configured to block a top of the battery. Opposite ends of the fixing member are configured to connect to the hooks, respectively.

### CROSS-REFERENCE OF RELATED APPLICATIONS

Relevant subject matter is disclosed in a pending U.S. patent application, titled “MOUNTING DEVICE FOR BATTERY”, filed on Nov. 9, 2011, with the application Ser. No. 13/293,082, which is assigned to the same assignee as this patent application.

### BACKGROUND

1. Technical Field

The present disclosure relates to a device for mounting a battery.

2. Description of Related Art

In an electronic device, such as a server, a redundant array of independent disk (RAID) cards is electrically connected to a battery, to protect cached data from being lost because of a power failure. However, the mounting of the battery to the chassis of the server with screws is less than optimal for a maintenance or replacement operation.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is an exploded, isometric view of an exemplary embodiment of a mounting device together with a battery.

FIG. 2 is an assembled, isometric view of the mounting device and the battery of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

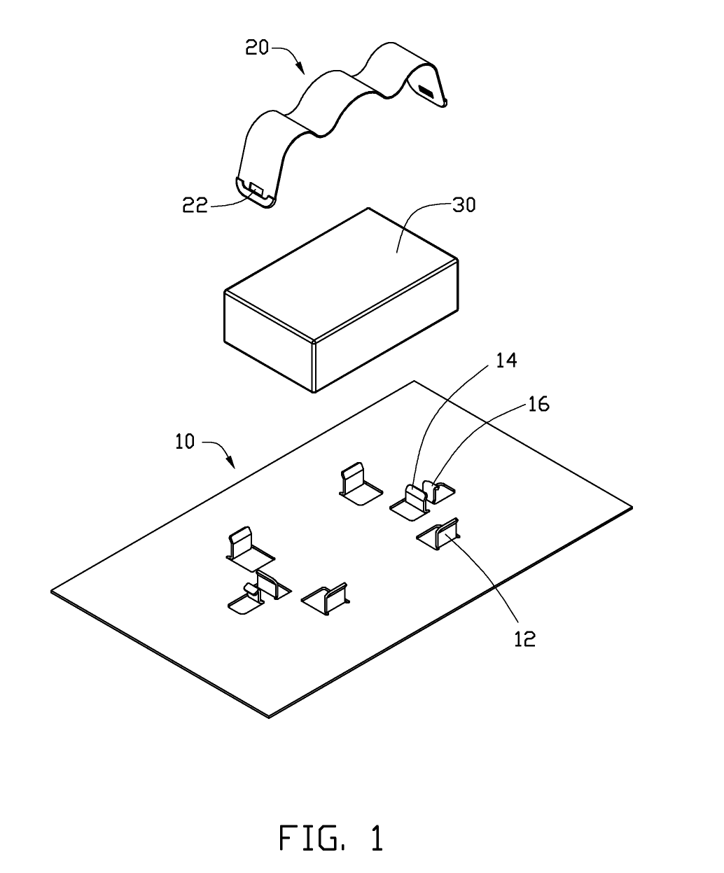

Referring to FIG. 1, an exemplary embodiment of a mounting device for mounting a battery 30 includes a base board 10 and a fixing member 20.

Two rows of first elastic tabs 12 and two second elastic tabs 14 positioned at opposite ends of the rows of first tabs 12 perpendicularly extend up from the base board 10. The second tabs 14 are perpendicular to the first tabs 12 and are between the rows of first tabs 12. Upper portions of the first and second tabs 12 and 14 slant outward. Two hooks 16 perpendicularly extend up from the base board 12 respectively adjacent to the outer sides of the second tabs 14.

The fixing member 20 is wave-shaped, and may be deformed. Two fixing holes 22 are defined in opposite ends of the fixing member 20.

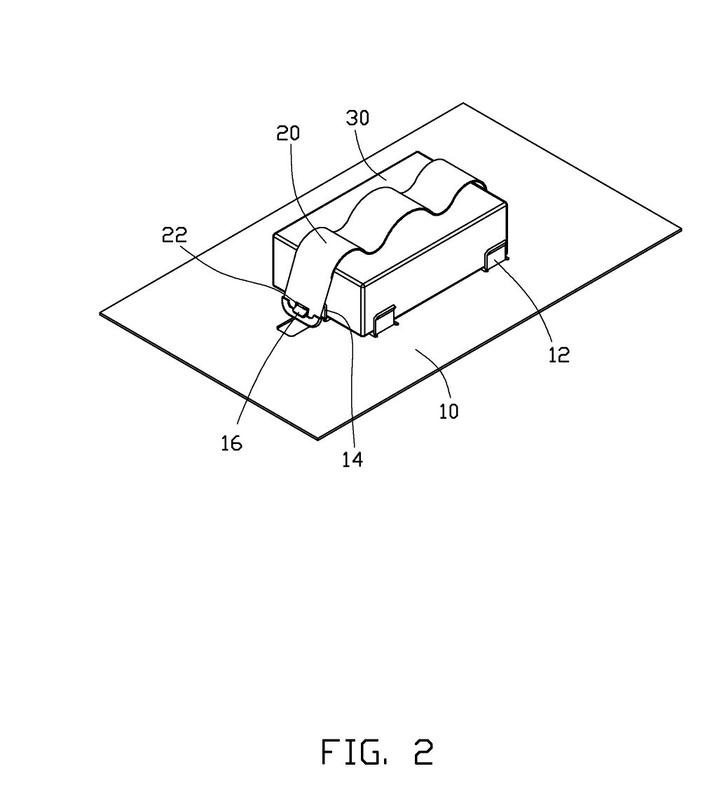

Referring to FIG. 2, in assembly, the battery 30 is put on the base board 10 and is accommodated in the space among the first and second tabs 12 and 14. The slanted upper portions of the first and second tabs 12 and 14 guide the battery 30 down into the space bounded by the first and second tabs 12 and 14. The first and second tabs 12 and 14 hold the battery 30 captive. The fixing member 20 abuts against the top of the battery 30. The hooks 16 are respectively engaged in the corresponding fixing holes 22. In this way, the battery 30 is held in place from every direction but may quickly and easily be removed and replaced.

In another embodiment, the second tabs 14 may be omitted, and the hooks 16 may directly abut against opposite ends of the battery 30.

It is believed that the present embodiments and their advantages will be understood from the foregoing description, and various changes may be made thereto without departing from the spirit and scope of the description or sacrificing all of their material advantages, the examples hereinbefore described merely being exemplary embodiments.

What is claimed is:

1. A mounting device for mounting a battery, comprising:
a base board to support the battery, the base board forming two first tabs to abut against opposite sides of the battery and two hooks located at opposite ends of the battery; and
a fixing member to block a top of the battery, opposite ends of the fixing member being configured to be connected to the hooks, respectively.

2. The mounting device of claim 1, wherein the fixing member is substantially wave-shaped and is operable to be deformed.

3. The mounting device of claim 2, wherein two fixing holes are defined in the opposite ends of the fixing member, the hooks are engaged in the fixing holes.

4. The mounting device of claim 1, wherein two second tabs extend from the base board to abut against the opposite ends of the battery, and the hooks are adjacent to outer sides of the corresponding second tabs.

5. A battery assembly, comprising:
a battery;
a base board supporting the battery, the base board forming two first tabs abutting against opposite sides of the battery and two hooks located at opposite ends of the battery; and
a fixing member blocking a top of the battery, opposite ends of the fixing member being connected to the hooks, respectively.

6. The battery assembly of claim 5, wherein the fixing member is substantially wave-shaped and is operable to be deformed.

7. The battery assembly of claim 6, wherein two fixing holes are defined in the opposite ends of the fixing member, the hooks are engaged in the fixing holes.

8. The battery assembly of claim 5, wherein two second tabs extend from the base board and abut against the opposite ends of the battery, the hooks are adjacent to outer sides of the corresponding second tabs.
